(19) United States
(12) Patent Application Publication
(10) Pub. No.: US 2025/0306866 A1
(43) Pub. Date: Oct. 2, 2025

(54) CREATING APPLICATIONS

(71) Applicant: Beijing Zitiao Network Technology Co., Ltd., Beijing (CN)

(72) Inventor: Yuyang Pan, Beijing (CN)

(21) Appl. No.: 18/756,736

(22) Filed: Jun. 27, 2024

(30) Foreign Application Priority Data
Mar. 29, 2024 (CN) 2024103831227

(51) Int. Cl. G06F 8/34; G06F 3/04845

(52) U.S. Cl. CPC G06F 8/34; G06F 3/04845

(57) ABSTRACT

Embodiments of the present disclosure relate to creating an application. The method comprises: obtaining configuration information, the configuration information indicating a plurality of processing entities for creating an application, the plurality of processing entities comprising a first processing entity and a set of second processing entities associated with the first processing entity, the configuration information comprising description information related to each of the set of second processing entities, the first processing entity being configured to determine whether to switch to a second processing entity to process a request based on the description information of the set of second processing entities; and creating a target application based on the configuration information. In this manner, embodiments of the present disclosure enable a specific processing entity to perform a decision on whether to jump based on a user's configuration of description information of a set of processing entities.

### CROSS-REFERENCE TO RELATED APPLICATIONS

This application claims priority to Chinese Patent Application No. CN2024103831227, filed on Mar. 29, 2024, and entitled “METHOD, APPARATUS, DEVICE AND STORAGE MEDIUM FOR CREATING APPLICATION”, the entirety of which is incorporated here by reference.

### FIELD

Example embodiments of the present specification generally relate to the field of computers, and more particularly, to creating applications.

### BACKGROUND

With the development of computer technology, people may create and publish various types of applications through different platforms. For example, with the development of machine learning techniques, people can quickly create applications by configuring parameters of the application, such as models used by the application, available plug-ins, and so on.

### SUMMARY

In a first aspect of the present disclosure, a method for creating an application is provided. The method comprises: obtaining configuration information, the configuration information indicating a plurality of processing entities for creating an application, the plurality of processing entities comprising a first processing entity and a set of second processing entities associated with the first processing entity, the configuration information comprising description information related to the set of second processing entities, the first processing entity being configured to determine whether to switch to a particular second processing entity of the set of second processing entities to process a request based on the description information of each second processing entity of the set of second processing entities, the description information indicating an applicable scenario and/or a function of a corresponding second processing entity; and creating a target application based on the configuration information.

In a second aspect of the present disclosure, an apparatus for creating an application is provided. The apparatus comprises: an obtaining module, configured to obtain configuration information, the configuration information indicating a plurality of processing entities for creating an application, the plurality of processing entities comprising a first processing entity and a set of second processing entities associated with the first processing entity, the configuration information comprising description information related to the set of second processing entities, the first processing entity being configured to determine whether to switch to a particular second processing entity of the set of second processing entities to process a request based on the description information of each second processing entity of the set of second processing entities, the description information indicating an applicable scenario and/or a function of a corresponding second processing entity; and a creating module, configured to create a target application based on the configuration information.

In a third aspect of the present disclosure, an electronic device is provided. The device comprising at least one processing unit; and at least one memory coupled to the at least one processing unit and storing instructions for execution by the at least one processing unit, in response to the instructions being executed by the at least one processing unit, the processor causing the electronic device to perform operations that implement the method of the first aspect.

In a fourth aspect of the present disclosure, a computer readable storage medium is provided, on which a computer program is stored, wherein the computer program is executable by a processor to perform operations that implement the method in the first aspect.

It should be understood that the contents described in this section are not intended to limit the key features or important features of the present disclosure, nor are they intended to limit the scope of the disclosure. Other features of the disclosure will become readily understood from the following description.

### BRIEF DESCRIPTION OF THE DRAWINGS

The above and other features, advantages and aspects of the various embodiments of the present disclosure will become more apparent in conjunction with the accompanying drawings and with reference to the following detailed description. In the drawings, same or similar reference numbers denote same or similar elements, wherein:

FIG. 1 illustrates a schematic diagram of an example environment.

FIG. 2 illustrates a flowchart of an example process of creating an application.

FIGS. 3A-3C illustrate example user interfaces.

FIG. 4 illustrates a schematic structural block diagram of an example apparatus for creating an application.

FIG. 5 illustrates a block diagram of an electronic device capable of implementing application creation.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be understood as “based at least in part on.” The term “one embodiment” or “the embodiment” should be understood as “at least one embodiment”. The term “some embodiments” should be understood as “at least some embodiments.” Other explicit and implicit definitions may also be included below. The terms “first”, “second”, etc. may refer to different or identical objects. Other explicit and implicit definitions may also be included below.

Embodiments of the present disclosure may relate to data of users, data acquisition and/or use of data, etc. All of these aspects follow respective legal regulations and related regulations. In embodiments of the present disclosure, all data collection, acquisition, processing, manufacturing, forwarding, using, and the like, are made with user acknowledgement and confirmation. Accordingly, when implementing the embodiments of the present disclosure, the user should be informed of a type, a usage range, a usage scenario, and the like of the data or information involved in an appropriate manner according to relevant legal regulations, and the authorization of the user is obtained. The specific informing and/or authorization manner may vary according to actual situations and application scenarios, and the scope of the present disclosure is not limited in this aspect.

In the solution of the present description and the embodiments, the personal information processing is performed on the basis of legitimacy (for example, the consent of the personal information body is obtained, or necessary for fulfillment of a contract, etc.), and the personal information processing is performed only within a predetermined range or a regulated range. The user's rejection of processing the personal information other than the necessary information required for processing the basic function will not affect the use of the basic function by the user.

Conventionally, a user can configure a model, a plug-in, and the like used by an application to quickly create an application, for example, a robot program (bot). However, such applications typically correspond to a single processing entity, e.g., a single agent. Because a single processing entity typically has strong processing capabilities in a particular field, the requests that an application can process are limited and it is difficult to efficiently process more complex requests.

Embodiments of the present disclosure propose a solution for creating an application. According to the solution: configuration information may be obtained, the configuration information indicating a plurality of processing entities for creating an application, the plurality of processing entities comprising a first processing entity and a set of second processing entities associated with the first processing entity, the configuration information comprising description information related to the set of second processing entities, the first processing entity being configured to determine whether to switch to a second processing entity to process a request based on the description information of the set of second processing entities, the description information indicating an applicable scenario and/or a function of a corresponding second processing entity. Further, the target application may be created based on the configuration information.

In this manner, embodiments of the present disclosure enable a specific processing entity to perform a decision on whether to jump based on a user's configuration of description information of a set of processing entities, thereby completing the creation of an application (e.g., a bot based on a multi-processing entity).

Various example implementations of the solution are described in further detail below with reference to the accompanying drawings.

### Example Environment

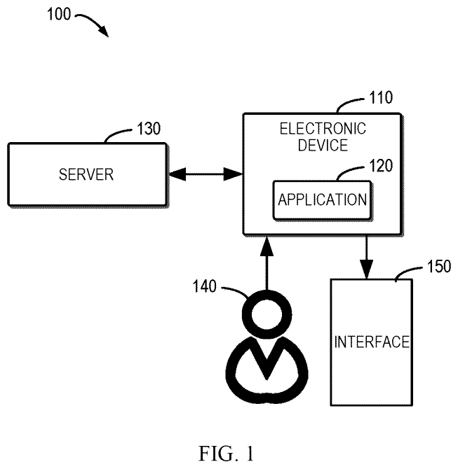

FIG. 1 shows a schematic diagram of an example environment 100 in which embodiments of the present disclosure can be implemented. As shown in FIG. 1, the example environment 100 may include an electronic device 110.

In this example environment 100, the electronic device 110 may execute an application 120 that supports interface interaction. The application 120 can be any suitable type of application for interface interaction, examples of which may include, but are not limited to, a development application or other suitable application that supports application development. User 140 may interact with application 120 via electronic device 110 and/or an attached device thereof.

In the environment 100 of FIG. 1, if the application 120 is active, the electronic device 110 may present an interface 150 for supporting application creation through the application 120.

In some embodiments, electronic device 110 communicates with server 130 to enable the provision of services to application 120. The electronic device 110 may be any suitable type of mobile terminal, fixed terminal, or portable terminal, including, for example, a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, electronic device 110 may also support any type of interface for a user (such as a ‘wearable’ circuit or the like).

The server 130 may be an independent physical server. The server 130 may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. Server 130 may include, for example, a computing system/server, such as a mainframe, an edge computing node, a computing device in a cloud environment, etc. The server 130 may provide background services for the application 120 which supports virtual scenes in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (WiFi) connections, and the like, to which embodiments of the present disclosure are not limited. In embodiments of the present disclosure, the server 130 and the electronic device 110 may enable signaling interaction through a communication connection there between.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Processes

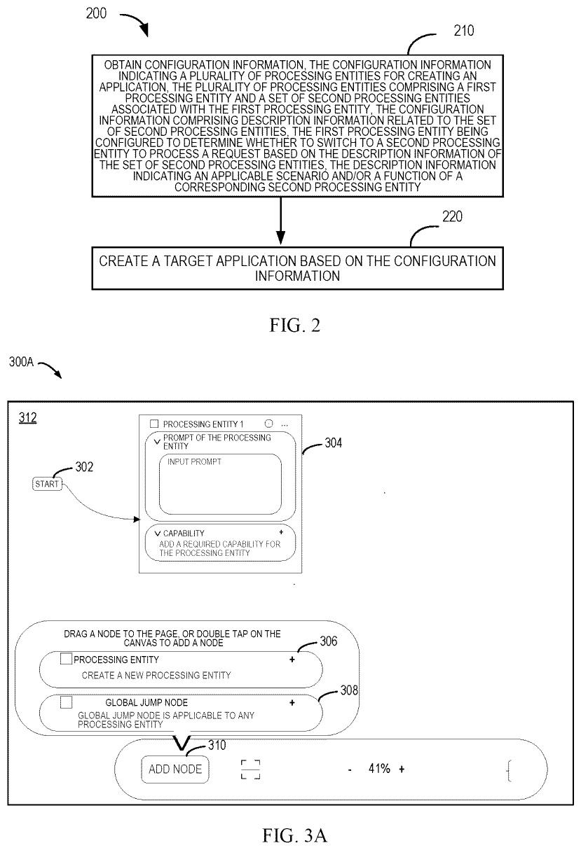

FIG. 2 illustrates a flowchart of an example process 200 for creating an application, according to some embodiments of the disclosure. The process 200 may be implemented at the electronic device 110. Process 200 is described below with reference to FIG. 1.

As shown in FIG. 2, at block 210, the electronic device 110 obtains configuration information, wherein the configuration information indicates a plurality of processing entities for creating an application, the plurality of processing entities comprising a first processing entity and a set of second processing entities associated with the first processing entity. Additionally, the configuration information comprises description information related to the set of second processing entities, the first processing entity being configured to determine whether to switch to a second processing entity to process a request based on the description information of the set of second processing entities. In some embodiments, the description information indicates an applicable scenario and/or a function of a corresponding second processing entity.

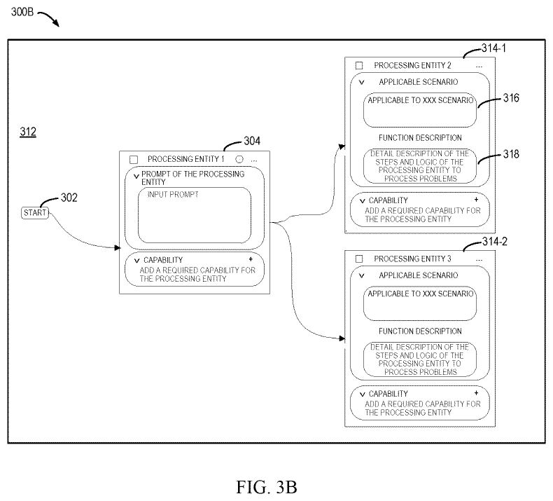

In some embodiments, the electronic device 110 may support a user configuration of a plurality of processing entities included in an application to create an application. Such a plurality of processing entities may include, for example, two or more agents or sub-applications (e.g., bots). An example process of obtaining configuration information in accordance with some embodiments of the disclosure will be described below in connection with FIGS. 3A-3F.

In some embodiments, electronic device 110 can provide an editing interface 300A as shown in FIG. 3A. In interface 300A, electronic device 110 may support a user to create a node connection graph 312. Such a node connection graph may comprise a starting node 302 and a plurality of nodes corresponding to a plurality of processing entities, e.g., a node 304 corresponding to “processing entity 1”, etc.

With continued reference to FIG. 3A, the electronic device 110 may support the user to add one or more new nodes to the node connection graph 312 via a control 310. For example, a user may add a new node corresponding to a processing entity (e.g., an agent or a bot) via the control 306.

As an example, as shown in FIG. 3B, a user may add a node 314-1 corresponding to “processing entity 2” and a node 314-2 corresponding to “processing entity 3” to the node connection graph 312 via the control 306.

Further, as shown in FIG. 3C, the user may perform a property editing operation on a specific node comprised in the node connection graph. Using node 314 as an example, electronic device 110 may allow a user to edit the property of “processing entity 2” corresponding to node 314.

For example, the electronic device 110 may obtain the description information for the “processing entity 2” via the control 316 and control 318. In some embodiments, the control 316 may be used to obtain scenario description information about the scenario to which “processing entity 2” is applicable. The control 318 may be configured to obtain function description information of the function of the “processing entity 2”.

In some embodiments, such description information may comprise, for example, text content input by the user via the control 316 and/or control 318.

In some embodiments, the electronic device 110 may also add corresponding capabilities to the “processing entity 2”. Such capabilities may include, but are not limited to, plug-in capabilities, tool capabilities, and knowledge capabilities, etc.

In particular, the electronic device 110 may, for example, configure the plug-in information, tool information or knowledge base information of the “processing entity 2”. The electronic device 110 may support adding one or more plug-ins, adding one or more tools, and/or adding one or more knowledge bases for the “processing entity 2”.

Additionally, the electronic device 110 may also allow the user to modify other properties of the “processing entity 2.” For example, the electronic device 110 may allow the user to modify the name of the “processing entity 2”; support the user to add a new processing entity with the same properties to the node connection graph; and support the user to delete the node 314-1, etc.

Additionally, the electronic device 110 may also allow the user to modify the model information of the “processing entity 2”. For example, the electronic device 110 may determine a model corresponding to the “processing entity 2” via the control 332 and allow the user to modify relevant parameters of the model, such as temperature and maximum response length.

Similarly, the electronic device 110 may, for example, configure the node 314-2 in a same manner.

With continued reference to FIG. 3C, the electronic device 110 may also support configuring connection relationships of nodes in the node connection graph 312. Specifically, as shown in FIG. 3B, the electronic device 110 may add a connection between the node 304 and the node 314-1, or add a connection between the node 304 and the node 314-2, based on the editing operation of the user.

In some embodiments, such a node connection may indicate an association relationship between the node 304 and the node 314-1 or 314-2 to indicate that the node 304 may jump to the node 314-1 or node 314-2 to process the task.

In some embodiments, such a node 304 may also be referred to as a “host node”. Node 304 may establish node connections with one or more other nodes, and determine, based on the description information of the one or more other nodes, whether to jump to the corresponding node to process the request.

In some embodiments, as illustrated in FIG. 3B, node 304 may be the starting node in the node connection graph 312, such that the newly received request is always sent to the node 304 first to perform the decision of which node to jump to for processing the task.

In some embodiments, in order to support a jump from “processing entity 1” to “processing entity 2” or “processing entity 3”, the electronic device 110 may create a corresponding jump plug-in for the “processing entity 1” based on the description information of the “processing entity 2” and the “processing entity 3”. This enables the “processing entity 1” to independently determine whether the jump plug-in needs to be used under the current scenario, to execute the switch from the “processing entity 1” to the “processing entity 2” or the “processing entity 3”. In some examples, where the “processing entity 1” creates a jump plug-in, a suggested interaction item for the “processing entity 1” may also be generated based on the jump plug-in.

With the increase of the number of nodes, in some scenarios, the user may desire to configure a global jump condition. As shown in FIG. 3A, the electronic device 110 may also allow the user to configure global jump information via a control 308. The global jump information may indicate that at least one other processing entity other than the target processing entity in the node connection graph is capable of switching to the target processing entity to process the request under a uniform specific condition. In some embodiments, the global jump information may indicate that all processing entities, except for the target processing entity, in the node connection graph are capable of switching to the target processing entity to process the request under a uniform specific condition.

As shown in FIG. 3C, after receiving the selection of the control 308, the electronic device 110 may add a global jump node 320 to the node connection map 312. Further, the electronic device 110 may establish a connection from the global jump node 320 to the node 314-2 based on a user's configuration operation, and obtain a corresponding jump condition via the control 322.

Based on the configuration operation, for an application to be created, all other processing entities other than the “processing entity 3” may determine whether to switch to the “processing entity 3” based on the “global jump condition 2” while they are running. By supporting the user to create the global jump node, the embodiment of the present disclosure can further improve the editing efficiency of the user.

In some embodiments, after the target application is published based on the node connection graph 312, the target application may perform a switching between processing entities during the processing of the target request. For example, after the target application receives a target request to be processed, the target application may provide the target request to the “processing entity 1”, and the target processing entity for processing the target request is determined by the “processing entity 1” based on the description information of the associated other processing entities (e.g., the “processing entity 2” and “processing entity 3”).

By way of example, the “processing entity 2” may provide the functionality of weather inquiry, and the “processing entity 3” may provide the functionality of traffic inquiry. Thus, in response to receiving a user's related request for a weather inquiry, the “processing entity 1” may determine to jump to the “processing entity 2” to process the request based on the description information of the “processing entity 2”.

Further, the target application may switch to the determined target processing entity (e.g., “processing entity 2”) to process the target request.

In some embodiments, after the target request is processed to completion, the target application may switch back to the “processing entity 1” for processing other requests that are subsequently received.

For example, if the user further enters a request for a traffic query, then “processing entity 1” may continue to determine, according to the request, that switching to “processing entity 3” is required to process the request.

Thus, embodiments of the present disclosure are capable of improving execution efficiency of a target application by configuring a host node to perform distribution and streaming of requests according to description information of other processing entities.

As discussed above, the electronic device 110 may support various types of editing operations on the node connection graph 312 by the user, e.g., adding new nodes, deleting existing nodes, editing node properties, modifying node connection relationships, and so on. It should be understood that, although the discussion above is discussed with reference to the manner of the node connection graph for obtaining the configuration information, the electronic device 110 may also, for example, support a user inputting the configuration information in other suitable manners.

By way of example, the electronic device 110 may, for example, support a user configuring a plurality of processing entities and jump information between processing entities by way of code editing. Alternatively, the electronic device 110 may also configure the associations between processing entities and processing entities through a data table or the like.

As an example, electronic device 110 may support configuring a type property of a node (such as node 314-1 or node 314-2) to indicate that description information of the node may be provided to node 304 to be used by node 304 to determine whether to jump to the node. In this case, for example, the user may not need to add a connection between the nodes, thereby improving efficiency of node configuration.

As yet another example, an upper limit on the number of other nodes allowed to be associated with node 304 may also be set, thereby avoiding the logic of “processing entity 1” being too complex, which improves the execution efficiency of the created application.

With continued reference to FIG. 2, at block 220, the electronic device 110 creates a target application based on the configuration information.

As an example, the electronic device 110 may create a corresponding target application, e.g., a bot, based on the configuration information. Further, for example, the bot may be released or shared to other users.

In some embodiments, in response to an allowance of a publisher, for example, other users may also be supported to create a template of a published application, and a new application may be created by editing a corresponding node connection graph, thereby improving the efficiency of the application.

### Example Apparatus and Devices

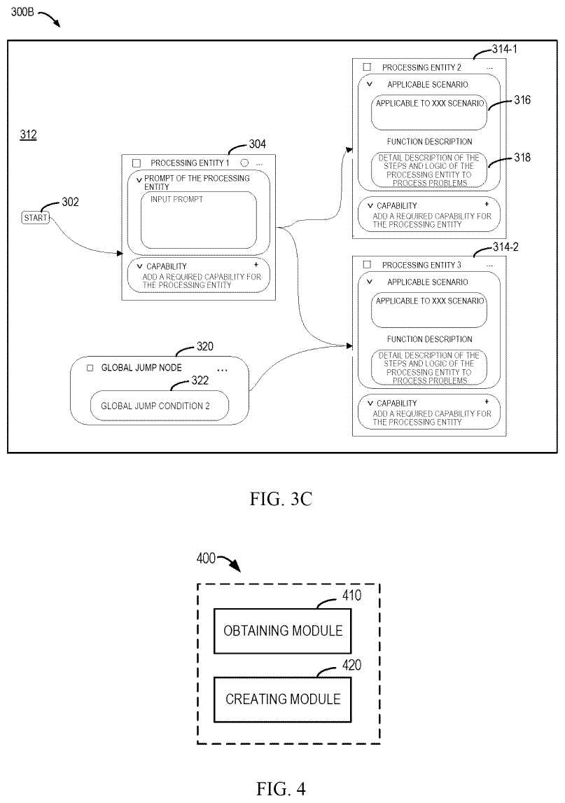

Embodiments of the present disclosure also provide a corresponding apparatus for implementing methods or processes described above. FIG. 4 illustrates a schematic structural block diagram of an example apparatus 400 for creating an application, in accordance with certain embodiments of the present disclosure. The apparatus 400 may be implemented as or included in the electronic device 110 of FIG. 1. The various modules/components in the apparatus 400 may be implemented by hardware, software, firmware, or any combination thereof.

As shown in FIG. 4, apparatus 400 includes an obtaining module 410 configured to: obtain configuration information, the configuration information indicating a plurality of processing entities for creating an application, the plurality of processing entities comprising a first processing entity and a set of second processing entities associated with the first processing entity. The configuration information comprises description information related to the set of second processing entities. The first processing entity is configured to determine whether to switch to a particular second processing entity of the set of second processing entities to process a request based on the description information of each second processing entity of the set of second processing entities, the description information indicating an applicable scenario and/or a function of a corresponding second processing entity. The apparatus 400 also includes a creating module 420 configured to create a target application based on the configuration information.

In some embodiments, the obtaining module 410 is further configured to: create a node connection graph via an editing interface, the node connection graph comprising a plurality of nodes, each node corresponding to a respective processing entity of the plurality of processing entities, the plurality of nodes comprising a first node corresponding to the first processing entity and a set of second nodes corresponding to the set of second processing entities, and the node connection graph comprising one or more connections between the first node and corresponding second nodes of the set of second nodes, each connection indicating an association relationship between the first processing entity and the corresponding second entity; and determine the configuration information based on the node connection graph.

In some embodiments, the obtaining module 410 is further configured to: receive a set of editing operations via the editing interface to create the node connection graph, wherein the set of editing operations comprises at least one of the following: adding a new node to the node connection graph; deleting an existing node in the node connection graph; editing a property of a node in the node connection graph; or modifying a connection relationship of a node in the node connection graph.

In some embodiments, the first node is a starting node in the node connection graph.

In some embodiments, the acquisition module 410 is further configured to: present a configuration interface related to a second processing entity; and obtain the description information related to the second processing entity via the configuration interface.

In some embodiments, the description information comprises a text content input via the configuration interface.

In some embodiments, the apparatus 400 further comprises a plug-in creating module configured to: create a set of jump plug-ins of the first processing entity based on the description information of the set of second processing entities, such that the first processing entity is configured to selectively switch to a corresponding second processing entity by invoking the jump plug-in.

In some embodiments, the configuration information comprises global jump information indicating that at least one other processing entity other than a third processing entity among the plurality of processing entities is configured to selectively switch to the third processing entity to process a request under a target condition.

In some embodiments, the apparatus 400 further comprises a node creating module configured to: create a global jump node corresponding to the global jump information in an editing interface.

In some embodiments, apparatus 400 further comprises a processing module configured to: in response to the target application receiving a target request to be processed, provide the request to the first processing entity by the target application; determine, by the first processing entity, a target processing entity for processing the target request from the set of second processing entities based on the description information of the set of second processing entities; and switch to the target processing entity to process the target request by the target application.

In some embodiments, the processing module is further configured to: in response to completing the target request processing, switch back to the first processing entity to process a subsequently received request by the target application.

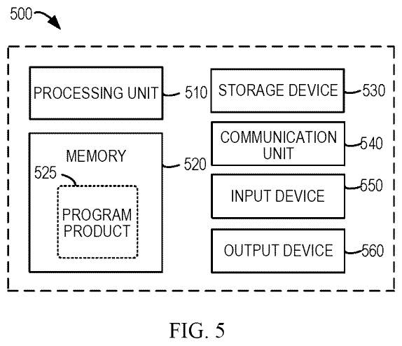

FIG. 5 illustrates a block diagram of an example electronic device 500 in which one or more embodiments of the present disclosure may be implemented. It should be understood that the electronic device 500 shown in FIG. 5 is merely exemplary and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a generic electronic device. The components of the electronic device 500 may include, but are not limited to, one or more processors or processing units 510, memory 520, storage 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units execute computer executable instructions in parallel to improve the parallel processing capability of the electronic device 500.

The electronic device 500 typically includes a plurality of computer storage media. Such media may be any available media that is accessible to the electronic device 500, including, but not limited to, volatile and non-volatile media, removable and non-removable media. The memory 520 may be a volatile memory (e.g., registers, cache, random access memory (RAM)), non-volatile memory (e.g., read-only memory (ROM), electrically erasable programmable read-only memory (EEPROM), flash memory), or some combination thereof. Storage 530 may be a removable or non-removable medium and may include a machine-readable medium such as a flash drive, a magnetic disk, or any other medium that may be used to store information and/or data and that may be accessed within electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speakers, printer, etc. The electronic device 500 may also communicate with one or more external devices (not shown), such as storage devices, display devices, etc., as needed through the communication unit 540, with one or more devices that enable a user to interact with the electronic device 500, or with any device (e.g., network card, modem, etc.) that enables the electronic device 500 to communicate with one or more other electronic devices. Such communication may be performed via an input/output (I/O) interface (not shown).

According to some exemplary implementations of the present disclosure, a computer-readable storage medium is provided, on which a computer-executable instruction is stored, wherein the computer-executable instruction is executed by a processor to perform operations that implement the above-described method. According to an exemplary implementation of the present disclosure, there is also provided a computer program product, which is tangibly stored on a non-transitory computer-readable medium and includes computer-executable instructions that are executed by a processor to implement the method described above.

Aspects of the present disclosure are described here with reference to flowchart illustrations and/or block diagrams of methods, apparatus, devices and computer program products implemented in accordance with the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processing unit of a general purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices perform operations that implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the disclosure above, the foregoing description provides a number of examples, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

1. A method for creating an application, comprising:
obtaining configuration information for creating an application, the configuration information indicating a plurality of processing entities, the plurality of processing entities comprising a first processing entity and a set of second processing entities associated with the first processing entity, the configuration information comprising description information related to the set of second processing entities, the first processing entity being configured to determine whether to switch to a particular second processing entity of the set of second processing entities to process a request based on the description information of each second processing entity of the set of second processing entities, the description information of each second processing entity indicating one or more of an applicable scenario or a function of the second processing entity; and
creating a target application based on the configuration information.

2. The method of claim 1, wherein obtaining configuration information comprises:
creating a node connection graph via an editing interface, the node connection graph comprising a plurality of nodes, each node corresponding to a respective processing entity of the plurality of processing entities, the plurality of nodes comprising a first node corresponding to the first processing entity and a set of second nodes corresponding to the set of second processing entities, and the node connection graph comprising one or more connections between the first node and corresponding second nodes of the set of second nodes, each connection indicating an association relationship between the first processing entity and the corresponding second entity; and
determining the configuration information based on the node connection graph.

3. The method of claim 2, wherein creating a node connection graph via an editing interface comprises: receiving a set of editing operations via the editing interface to create the node connection graph,
wherein the set of editing operations comprises at least one of the following:
adding a new node to the node connection graph;
deleting an existing node in the node connection graph;
editing a property of a node in the node connection graph; or
modifying a connection relationship of a node in the node connection graph.

4. The method of claim 2, wherein the first node is a starting node in the node connection graph.

5. The method of claim 1, wherein obtaining configuration information comprises:
presenting a configuration interface related to a second processing entity; and
obtaining the description information related to the second processing entity via the configuration interface.

6. The method of claim 5, wherein the description information comprises a text content input via the configuration interface.

7. The method of claim 1, further comprising:
creating a set of jump plug-ins of the first processing entity based on the description information of the set of second processing entities, such that the first processing entity is configured to selectively switch to a corresponding second processing entity by invoking the jump plug-in.

8. The method of claim 1, wherein the configuration information comprises global jump information indicating that at least one other processing entity other than a third processing entity among the plurality of processing entities is configured to selectively switch to the third processing entity to process a request under a target condition.

9. The method of claim 8, further comprising:
creating a global jump node corresponding to the global jump information in an editing interface.

10. The method of claim 1, further comprising:
in response to the target application receiving a target request to be processed, providing the request to the first processing entity by the target application;
determining, by the first processing entity, a target processing entity for processing the target request from the set of second processing entities based on the description information of the set of second processing entities; and
switching to the target processing entity to process the target request by the target application.

11. The method of claim 10, further comprising:
in response to completing the target request processing, switching back to the first processing entity to process a subsequently received request by the target application.

12. An electronic device, comprising:
at least one processing unit;
at least one memory coupled to the at least one processing unit and storing instructions for execution by the at least one processing unit, in response to the instructions being executed by the at least one processing unit, the processor causing the electronic device to perform a method for creating an application comprising:
obtaining configuration information for creating an application, the configuration information indicating a plurality of processing entities, the plurality of processing entities comprising a first processing entity and a set of second processing entities associated with the first processing entity, the configuration information comprising description information related to the set of second processing entities, the first processing entity being configured to determine whether to switch to a particular second processing entity of the set of second processing entities to process a request based on the description information of each second processing entity of the set of second processing entities, the description information of each second processing entity indicating one or more of an applicable scenario or a function of the second processing entity; and
creating a target application based on the configuration information.

13. The electronic device of claim 12, wherein obtaining configuration information comprises:
creating a node connection graph via an editing interface, the node connection graph comprising a plurality of nodes, each node corresponding to a respective processing entity of the plurality of processing entities, the plurality of nodes comprising a first node corresponding to the first processing entity and a set of second nodes corresponding to the set of second processing entities, and the node connection graph comprising one or more connections between the first node and corresponding second nodes of the set of second nodes, each connection indicating an association relationship between the first processing entity and corresponding second entity; and
determining the configuration information based on the node connection graph.

14. The electronic device of claim 13, wherein creating a node connection graph via an editing interface comprises: receiving a set of editing operations via the editing interface to create the node connection graph,
wherein the set of editing operations comprises at least one of the following:
adding a new node to the node connection graph;
deleting an existing node in the node connection graph;
editing a property of a node in the node connection graph; or
modifying a connection relationship of a node in the node connection graph.

15. The electronic device of claim 13, wherein the first node is a starting node in the node connection graph.

16. The electronic device of claim 12, wherein obtaining configuration information comprises:
presenting a configuration interface related to a second processing entity; and
obtaining the description information related to the second processing entity via the configuration interface.

17. The electronic device of claim 16, wherein the description information comprises a text content input via the configuration interface.

18. The electronic device of claim 12, the method further comprising:
creating a set of jump plug-ins of the first processing entity based on the description information of the set of second processing entities, such that the first processing entity is configured to selectively switch to a corresponding second processing entity by invoking the jump plug-in.

19. The electronic device of claim 12, wherein the configuration information comprises global jump information indicating that at least one other processing entity other than a third processing entity among the plurality of processing entities is configured to selectively switch to the third processing entity to process a request under a target condition.

20. A non-transitory computer readable storage medium, on which a computer program is stored, wherein the computer program is executable by a processor to implement a method for creating an application comprising:
obtaining configuration information for creating an application, the configuration information indicating a plurality of processing entities, the plurality of processing entities comprising a first processing entity and a set of second processing entities associated with the first processing entity, the configuration information comprising description information related to the set of second processing entities, the first processing entity being configured to determine whether to switch to a particular second processing entity of the set of second processing entities to process a request based on the description information of each second processing entity of the set of second processing entities, the description information of each second processing entity indicating one or more of an applicable scenario or a function of the second processing entity; and
creating a target application based on the configuration information.
